(19) United States
(12) Patent Application Publication
(10) Pub. No.: US 2012/0153523 A1
(43) Pub. Date: Jun. 21, 2012

(54) PROCESS FOR PRODUCING LOW-DENSITY POLYURETHANE MOLDINGS

(75) Inventors: Andre Kamm, Bohmte (DE); Holger Haschke, Wagenfeld (DE)

(73) Assignee: BASF SE, Ludwigshafen (DE)

(21) Appl. No.: 13/324,138

(22) Filed: Dec. 13, 2011

Related U.S. Application Data
(60) Provisional application No. 61/423,609, filed on Dec. 16, 2010.

(51) Int. Cl. B29C 45/77; C08J 9/02

(52) U.S. Cl. 264/40.3; 264/54

(57) ABSTRACT

The present invention relates to a process for producing polyurethane foam moldings of density from 100 to 300 g/L, by mixing (a) organic polyisocyanates with (b) polyols, (c) with blowing agents comprising water, and optionally (d) with chain extenders and/or with crosslinking agents, (e) with catalysts, and (f) with other auxiliaries and/or additives, to give a reaction mix-ture, charging the material to a mold, and permitting it to react completely to give a polyurethane foam molding, where the free density of the polyurethane foam is from 90 to 200 g/L, and the mold has at least one device for controlling gauge pressure. The present invention further relates to a polyurethane foam molding obtainable by this type of process, and to the use of this type of polyurethane molding as shoe sole.

The present invention relates to a process for producing polyurethane foam moldings of density from 100 to 300 g/L, by mixing (a) organic polyisocyanates with (b) polyols, (c) with blowing agents comprising water, and optionally (d) with chain extenders and/or with crosslinking agents, (e) with catalysts, and (f) with other auxiliaries and/or additives, to give a reaction mixture, charging the material to a mold, and permitting it to react completely to give a polyurethane foam molding, where the free density of the polyurethane foam is from 90 to 200 g/L, and the mold has at least one device for controlling gauge pressure. The present invention further relates to a polyurethane foam molding obtainable by this type of process, and to the use of this type of polyurethane molding as shoe sole.

Within recent years, a trend toward lower-weight shoe soles can be observed. However, reduction of density of polyurethane shoe soles leads to problems in the production of the moldings, in particular when densities of the moldings are smaller than 300 g/L. Particularly when the usual water-blown systems are used, the molds are not completely filled, or there is an increased frequency of skin detachment at the surface of the moldings. Shrinkage of the moldings also occurs at a number of points, and is discernible through defects on the surface of the moldings. Finally, irregular cell morphology often occurs, giving the moldings nonuniform mechanical properties.

In the production of polyurethane shoe soles, a distinction is drawn in principle between the production of separate molded soles and direct injection onto the product. In the case of direct injection onto the product, complete shoes are produced within the process. The shoe upper functions as cover for the foam mold. After injection of the liquid polyurethane mixture, an adhesive bond is obtained between the shoe upper and the foaming reactive mixture, and, after demolding, there is therefore a firm bond between the completely reacted sole and the upper. By far the greater proportion of industrially produced polyurethane shoe soles is produced in the form of molded soles and subsequently adhesive-bonded to the upper and optionally to the outsole. A molded sole is obtained by taking a reactive polyurethane mixture composed of polyol, of additives, and of isocyanate prepolymers, and using a mixing unit, mostly a low-pressure machine, to discharge this into an open mold. Once said mixture has been charged, the mold is sealed by a cover. The liquid reactive polyurethane mixture expands within the mold and, during the reaction, changes from the liquid state to the solid state, and thus replicates the shape of the mold. The air which is present in the mold after the reactive mixture has been introduced is forced out of the mold by the reactive mixture by way of the contact area between mold cover and mold base. A certain portion of the reactive polyurethane mixture penetrates into the contact area between mold cover and mold base. This type of flash is also termed overflash, and requires appropriate downstream operations.

This type of flash is traditionally removed by cutters. However, this has the disadvantage that the visible surface of the sole is damaged, thus allowing faster penetration of moisture into the sole, with resultant accelerated hydrolysis. Another result of cutting to remove the flash is that when “in-mold coating” is used a differently colored strip appears. Again, this differently colored strip requires subsequent downstream operations, if a molded sole of uniform color is to be obtained.

The production of low-density molded polyurethane soles with densities smaller than 300 g/L is more difficult, since the amount of material that can be charged to the appropriate mold is smaller. This generally results in poor mold filling, or defects.

EP 461522 describes a process for producing water-blown polyurethane moldings as steering wheels, instrument panels, lids, for example for the glove box, armrests, and headrests, or spoilers, where a vacuum is applied to a closed mold and then a polyurethane reaction mixture is charged to the evacuated mold. The examples here provide evidence that without the application of vacuum the filling of the mold is inadequate and defects arise in the molding. In this context, EP 461522 says that a water content of more than 0.6% by weight, based on the polyol component, gives a foam which is hard and brittle.

In order to avoid defects and to improve mold filling for low-density foams, the amount of water added as blowing agent to the polyurethane system is usually greater. This causes increased urea formation and undesired continued expansion of the foam. This continued expansion can be considered to be a cause of irregular cell morphology and skin detachment. Furthermore, the higher pressure which has to be applied for mold filling forces more material between the mold lid and the mold base, thus producing more waste. The literature describes various methods for obtaining low-density polyurethane shoe soles. EP 1 726 612, for example, describes a process for producing low-density shoe soles in which carbon dioxide is also dissolved in the polyol component. This can give molding densities of 250 g/L and a compaction factor of from 1.5 to 2.0. The additional dissolved CO₂ increases the pressure of the reaction mixture in the closed mold, thus permitting mold filling with small compaction factors. The dissolved CO₂ here evaporates almost instantly when the temperature of the reaction mixture rises, and the reaction mixture, still of low molecular weight, completely fills the mold. EP 1 726 612 thus avoids the use of a higher proportion of water in the polyurethane mixture and the impairment of mechanical properties. A disadvantage of the process described in EP 1 726 612 is that the introduction of CO₂ into the polyol component is attended by additional apparatus cost, and moreover is possible only when polyetherols are used. EP 1 726 612 does not moreover solve the problem represented by the flash.

In the traditional processes for producing low-density molded soles, with the aim of avoiding skin detachment, the molds are also adjusted manually to certain positions or angles. Determination of the ideal angle or, respectively, entry point into the mold is expensive, and this has to be carried out manually for each individual mold in the production process.

It was therefore an object of the present invention to provide a process which is simple and cost-effective and which permits production of polyurethane foam moldings of density from 100 to 300 g/L with good mechanical properties, and which does not have the disadvantages of the traditional process.

Said object has been achieved via a process for producing polyurethane foam moldings of density from 100 to 300 g/L, by mixing (a) organic polyisocyanates (b) with polyols, (c) with blowing agents comprising water, and optionally (d) with chain extenders and/or with crosslinking agents, (e) with catalysts, and (f) with other auxiliaries and/or additives, to give a reaction mixture, charging the material to a mold, and permitting it to react completely to give a polyurethane foam molding, where the free density of the polyurethane foam is from 90 to 200 g/L, and the mold has at least one pressure-control device.

The (excess)-pressure-control device here allows controlled escape from the mold of the air which is comprised in the closed mold after the polyurethane reaction mixture has been charged. A device for controlling gauge pressure here can preferably be a valve or an aperture in the mold, particularly preferably an aperture in the mold. The aperture in the mold is preferably rectangular, square, ellipsoid, or round, and its longest-axis diameter is preferably from 0.15 mm to 9 mm, particularly preferably from 1 mm to 5 mm, and in particular from 1.5 mm to 4 mm. The cross-sectional area of an aperture, the aperture area, is preferably from 0.01 mm² to 60 mm², preferably from 0.5 mm² to 19 mm², and in particular from 1.7 to 12 mm². This allows air comprised within the mold to escape via the device for controlling gauge pressure, and gauge pressure in the mold is thus minimized. Said apertures are preferably present at regions of the subsequent molding which have minimum contact with moisture during use, an example in the case of shoe soles being a region which, during subsequent shoe production, is covered by other materials, for example an outsole or the footbed. When the polyurethane reaction mixture reaches the aperture during foaming in the mold it is preferable that a polyurethane plug forms in the aperture, so that very little escape of polyurethane reaction mixture occurs through the aperture. This can be achieved by adjusting the reaction mixture in such a way that its viscosity is already high when it flows into the aperture. Continuation of the blowing reaction in the mold can thus lead to a large rise in pressure within the mold, and this can have an advantageous effect on the integral structure of the polyurethane molding of the invention.

In one embodiment of the invention, the mold has only one pressure-control device. The location of this one pressure-control device is preferably in a region that is the last to be reached by the polyurethane reaction mixture in the mold.

However, it is also possible in another embodiment that there are a plurality of pressure-control devices present on one mold, for example up to 10, preferably from 2 to 7, and particularly preferably from 2 to 4. These can also allow deaeration behavior to differ at different sites within the mold, for example via use of apertures with different aperture areas. It is therefore possible that the polyurethane shoe sole has different properties, for example hardness values, in the environment of the respective pressure-control devices. By way of example it is therefore possible to obtain a shoe sole which has different hardness values in the forefoot region and in the heel region.

For the purposes of the invention, the degree of compaction means the ratio of the density of the molding to the free density of a polyurethane system. To determine the free density, the polyurethane reaction mixture is by way of example charged to an open beaker and permitted to complete its reaction at room temperature and atmospheric pressure. The volume and the mass of the hardened molding are then determined, and the free density is calculated as quotient from the mass and the volume. In one preferred embodiment of the invention, the compaction factor is at most 1.6, preferably from 1.1 to 1.5, and particularly preferably from 1.2 to 1.4. By way of example here, the polyurethane reaction mixture used to produce the polyurethane foam molding can be adjusted in such a way as to achieve said values.

The polyurethane foam moldings of the invention are preferably integral foams, in particular foams to DIN 7726. In one preferred embodiment, the invention provides integral foams based on polyurethanes with Shore hardness in the range from 20 to 90 A, preferably from 25 to 60 Shore A, in particular from 30 to 55 Shore A, measured to DIN 53505. In one particularly preferred embodiment of the invention, the hardness of the integral foams is from 45 to 70

Asker C, measured to JIS K 7312. The integral foams of the invention moreover preferably have tensile strengths of from 0.5 to 10 N/mm², preferably from 1 to 5 N/mm² and particularly preferably from 1.25 to 3 N/mm², measured to DIN 53504. The integral foams of the invention moreover preferably have an elongation of from 100 to 800%, preferably from 150 to 500%, and particularly preferably from 200 to 350%, measured to DIN 53504. The integral foams of the invention moreover preferably have a rebound resilience to DIN 53 512 of from 20 to 60%. Finally, the integral foams of the invention preferably have a tear propagation resistance of from 1 to 10 N/mm, preferably from 1.5 to 5 N/mm, measured to ASTM D3574. The polyurethane foam moldings of the invention are in particular polyurethane shoe soles and, in one particularly preferred embodiment, are midsoles.

The density of the polyurethane foam moldings of the invention is from 100 to 300 g/L, preferably from 120 to 250 g/L, and particularly preferably from 150 to 225 g/L. Density of the polyurethane foam molding here means the density averaged over the entire foam, and in the case of integral foams these data are therefore based on the average density of the entire foam inclusive of core and of external layer.

The organic and/or modified polyisocyanates (a) used for producing the polyurethane foam moldings of the invention comprise the aliphatic, cycloaliphatic, and aromatic di- or polyfunctional isocyanates known from the prior art (constituent a-1), and also any desired mixtures thereof. Examples are monomeric methanediphenyl diisocyanate (MMDI), for example methanediphenyl 4,4′-diisocyanate and methanediphenyl 2,4″-diisocyanate, and the mixtures of monomric methanediphenyl diisocyanates and of homologs of methanediphenyl diisocyanate having a larger number of rings (polymer MDI), tetramethylene diisocyanate, hexamethylene diisocyanate (HDI), isophorone diisocyanate (IPDI), tolylene 2,4- or 2,6-diisocyanate (TDI), and mixtures of the abovementioned isocyanates.

It is preferable to use 4,4′-MDI. The 4,4′-MDI preferably used can comprise from 0 to 20% by weight of 2,4′ MDI and small amounts, up to about 10% by weight, of allophanate- or uretonimine-modified polyisocyanates. It is also possible to use small amounts of polyphenylene polymethylene polyisocyanate (polymer MDI). The total amount of these high-functionality polyisocyanates should not exceed 5% by weight of the isocyanate used.

Polyisocyanate component (a) is preferably used in the form of polyisocyanate prepolymers. These polyisocyanate prepolymers are obtainable by reacting polyisocyanates (a-1) described above with polyols (a-2) to give the prepolymer, for example at temperatures of from 30 to 100° C., preferably at about 80° C.

Polyols (a-2) are known to the person skilled in the art and are described by way of example in “Kunststoffhandbuch, Band 7, Polyurethane” [Plastics handbook, volume 7, Polyurethanes], Carl Hauser Verlag, 3rd edition 1993, chapter 3.1. The polyols (a-2) used here preferably comprise the polyesterols described under b1).

Conventional chain extenders or crosslinking agents are optionally added to the abovementioned polyols during the production of the isocyanate prepolymers. Substances of this type are described under d) below.

In one embodiment of the invention, the organic polyisocyanates (a) used preferably comprise prepolymers which are obtainable via reaction of polyisocyanates (a-1) with polyols (a-2), where the polyols (b) and the polyols (a-2) are polyetherols.

In another embodiment of the invention, the organic polyisocyanates (a) used preferably comprise prepolymers which are obtainable via reaction of polyisocyanates (a-1) with polyols (a-2), where the polyols (b) and the polyols (a-2) are polyesterols

The method of producing an isocyanate prepolymer is preferably such that the isocyanate content in the prepolymer is from 8 to 28% by weight, particularly preferably from 10 to 25% by weight, and more particularly from 14 to 23% by weight.

The polyols b) used can by way of example comprise polyetherols or polyesterols having at least two hydrogen atoms reactive toward isocyanate groups. The number-average molar mass of polyols b) is preferably greater than 450 g/mol, particularly preferably from greater than 500 to smaller than 12 000 g/mol, and in particular from 600 to 8000 g/mol.

Polyetherols are produced by known processes, for example via anionic polymerization using alkali metal hydroxides or using alkali metal alcoholates as catalysts and with addition of at least one starter molecule which comprises from 2 to 3 reactive hydrogen atoms, or via cationic polymerization using Lewis acids, such as antimony pentachloride or boron fluoride etherate, from one or more alkylene oxides having from 2 to 4 carbon atoms in the alkylene moiety.

Examples of suitable alkylene oxides are propylene 1,3-oxide, butylene 1,2- or 2,3-oxide, and preferably ethylene oxide and propylene 1,2-oxide. Tetrahydrofuran monomer can also be used. Other catalysts that can also be used are multimetal cyanide compounds, known as DMC catalysts. The alkylene oxides can be used individually, in alternating succession, or in the form of a mixture. Preference is given to mixtures of propylene 1,2-oxide and ethylene oxide, where amounts of from 10 to 50% of the ethylene oxide are used in the form of ethylene oxide end-cap (“EO-cap”), in such a way that the resultant polyols have more than 70% of primary OH end groups.

Starter molecules that can be used are water or di- and trihydric alcohols, such as ethylene glycol, 1,2- and 1,3-propanediol, diethylene glycol, dipropylene glycol, 1,4-butanediol, glycerol, or trimethylolpropane.

The polyether polyols, preferably polyoxypropylene polyoxyethylene polyols, preferably have functionality of from 1.7 to 3, and their number-average molar masses are from 1000 to 12 000 g/mol, preferably from 1500 to 8000 g/mol, in particular from 2000 to 6000 g/mol.

By way of example, polyester polyols can be produced from organic dicarboxylic acids having from 2 to 12 carbon atoms, preferably aliphatic dicarboxylic acids having from 4 to 6 carbon atoms, and from polyhydric alcohols, preferably diols, having from 2 to 12 carbon atoms, preferably from 2 to 6 carbon atoms. Examples of dicarboxylic acids that can be used are: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids here can be used either individually or in else in a mixture with one another. It is also possible to use the appropriate dicarboxylic derivatives instead of the free dicarboxylic acids, examples being dicarboxylic esters of alcohols having from 1 to 4 carbon atoms, and dicarboxylic anhydrides. It is preferable to use dicarboxylic acid mixtures made of succinic, glutaric, and adipic acid in quantitative proportions of, for example, from 20 to 35: from 35 to 50: from 20 to 32 parts by weight, and in particular adipic acid. Examples of di- and polyhydric alcohols, in particular diols, are: ethanediol, diethylene glycol, 1,2- and 1,3-propanediol, dipropylene glycol, 1,4-butanediol, 1,5-pentanediol, 1,6-hexanediol, 1,10-decanediol, glycerol, and trimethylolpropane. It is preferable to use ethanediol, diethylene glycol, 1,4-butanediol, 1,5-pentanediol, and 1,6-hexanediol. It is also possible to use polyester polyols made of lactones, e.g. ε-caprolactone, or hydroxycarboxylic acids, e.g. ω-hydroxycaproic acid.

To produce the polyester polyols, the organic, e.g. aromatic and preferably aliphatic, polycarboxylic acids and/or their derivatives, and polyhydric alcohols, can be polycondensed without catalyst or preferably in the presence of esterification catalysts, advantageously in an atmosphere of inert gas, e.g. nitrogen, carbon monoxide, helium, or argon, in the melt at temperatures of from 150 to 250° C., preferably from 180 to 220° C., optionally at reduced pressure, until the desired acid number, which is preferably less than 10 and particularly preferably less than 2, has been reached. In one preferred embodiment, the esterification mixture is polycondensed at the abovementioned temperatures as far as an acid number of from 80 to 30, preferably from 40 to 30, under atmospheric pressure, and then under a pressure smaller than 500 mbar, preferably from 50 to 150 mbar. Examples of esterification catalysts used are iron catalysts, cadmium catalysts, cobalt catalysts, lead catalysts, zinc catalysts, antimony catalysts, magnesium catalysts, titanium catalysts, and tin catalysts, in the form of metals, of metal oxides, or of metal salts. However, the polycondensation reaction can also be carried out in the liquid phase in the presence of diluents and/or entrainers, e.g. benzene, toluene, xylene, or chlorobenzene, for the removal of the water of condensation by azeotropic distillation. To produce the polyester polyols, the organic polycarboxylic acids and/or derivatives thereof, and polyhydric alcohols, are advantageously polycondensed in a molar ratio of 1:from 1 to 1.8, preferably 1:from 1.05 to 1.2.

The functionality of the resultant polyester polyols is preferably from 2 to 4, in particular from 2 to 3, their number-average molar mass being from 480 to 3000 g/mol, preferably from 1000 to 3000 g/mol.

Other suitable polyols are polymer-modified polyols, preferably polymer-modified polyesterols or polyetherols, particularly preferably graft polyetherols or graft polyesterols, in particular graft polyetherols. These are what is known as a polymer polyol which usually has from 5 to 60% by weight content of preferably thermoplastic polymers, preferably from 10 to 55% by weight, particularly preferably from 30 to 55% by weight, and in particular from 40 to 50% by weight. These polymer polyesterols are described by way of example in WO 05/098763 and EP-A-250 351, and are usually produced via free-radical polymerization of suitable olefinic monomers, such as styrene, acrylonitrile, (meth)acrylates, (meth)acrylic acid, and/or acrylamide, in a polyesterol serving as graft base. The side chains are generally produced via transfer of the free radicals from growing polymer chains onto polyesterols or polyetherols. The polymer polyol comprises, alongside the graft copolymers, mainly the homopolymers of the olefins, dispersed in unaltered polyesterol or, respectively, polyetherol.

In one preferred embodiment, the monomers used comprise acrylonitrile, or styrene, preferably acrylonitrile and styrene. The monomers are optionally polymerized in the presence of further monomers, of a macromer, i.e. of an unsaturated polyol capable of free-radical polymerization, and of a moderator, and with use of a free-radical initiator, mostly azo compounds or peroxide compounds, in a polyesterol or polyetherol as continuous phase. This process is described by way of example in DE 111 394, U.S. Pat. No. 3,304,273, U.S. Pat. No. 3,383,351, U.S. Pat. No. 3,523,093, DE 1 152 536, and DE 1 152 537.

During the free-radical polymerization reaction, the macromers are concomitantly incorporated into the copolymer chain. This gives block copolymers having a polyester block or, respectively, polyether block and a polyacrylonitrile-styrene block; these act as compatibilizers at the interface between continuous phase and disperse phase, and suppress agglomeration of the polymer polyesterol particles. The proportion of the macromers is usually from 1 to 20% by weight, based on the total weight of the monomers used to produce the polymer polyol.

If the material comprises polymer polyol, this is preferably present together with further polyols, for example polyetherols, polyesterols, or a mixture of polyetherols and polyesterols. The proportion of polymer polyol is particularly preferably greater than 5% by weight, based on the total weight of component (b). The amount of the polymer polyols comprised can by way of example, based on the total weight of component (b), be from 7 to 90% by weight, or from 11 to 80% by weight. The polymer polyol is particularly preferably polymer polyesterol or polymer polyetherol.

The polyols b) used preferably comprise mixtures comprising polyesterols. The proportion of polyesterols in the polyols (b) here is preferably at least 30% by weight, particularly preferably at least 70% by weight, and in particular the relatively high molecular weight compound (b) used comprises exclusively polyesterol, where a polymer polyol based on polyesterol is treated as a polyesterol for this calculation.

Blowing agents c) are also present in the production of polyurethane foam moldings. These blowing agents c) can comprise water. The blowing agent c) used can also comprise, alongside water, well-known compounds having chemical and/or physical action. The expression chemical blowing agents means compounds which form gaseous products, for example water or formic acid, via reaction with isocyanate. The expression physical blowing agents means compounds which have been emulsified or dissolved in the starting materials for polyurethane production and vaporize under the conditions of polyurethane formation. By way of example, these are hydrocarbons, halogenated hydrocarbons, and other compounds, such as perfluorinated alkanes, e.g. perfluorohexane, fluorochlorocarbons, and ethers, esters, ketones, acetals, or a mixture thereof, for example (cyclo)aliphatic hydrocarbons having from 4 to 8 carbon atoms, or fluorocarbons, such as Solkane® 365 mfc from Solvay Fluorides LLC. In one preferred embodiment, the blowing agent used comprises a mixture comprising at least one of said blowing agents and water, and it is particularly preferable to use no physical blowing agents and in particular to use water as sole blowing agent.

In one preferred embodiment, the water content is from 0.1 to 3% by weight, preferably from 0.4 to 2.0% by weight, particularly preferably from 0.6 to 1.7% by weight, and in particular from 0.7 to 1.5% by weight, based on the total weight of components b) to f).

In another preferred embodiment, hollow microbeads which comprise physical blowing agent are also added to the reaction of components a) to f). The hollow microbeads can also be used in a mixture with the abovementioned blowing agents.

The hollow microbeads are usually composed of a shell made from thermoplastic polymer, while their core comprises a liquid, low-boiling-point substance based on alkanes. Production of hollow microbeads of this type is described by way of example in U.S. Pat. No. 3,615,972. The diameter of the hollow microbeads is generally from 5 to 50 Examples of suitable hollow microbeads are obtainable with trademark Expancell® from Akzo Nobel.

The amount generally added of the hollow microbeads is from 0.5 to 5% by weight, based on the total weight of components b) and c). In one particularly preferred embodiment, the blowing agent used comprises a mixture of hollow microbeads and water, and the material here comprises no other physical blowing agents.

The chain extenders and/or crosslinking agents d) used comprise substances with molar mass preferably smaller than 450 g/mol, particularly preferably from 60 to 400 g/mol, where chain extenders have 2 hydrogen atoms reactive toward isocyanates and crosslinking agents have 3 hydrogen atoms reactive toward isocyanate. These can preferably be used individually or in the form of a mixture. It is preferable to use diols and/or triols having molecular weights smaller than 400, particularly preferably from 60 to 300, and in particular from 60 to 150. Examples of those that can be used are aliphatic, cycloaliphatic, and/or araliphatic diols having from 2 to 14, preferably from 2 to 10, carbon atoms, e.g. ethylene glycol, 1,3-propanediol, 1,10-decanediol, 1,2-, 1,3-, or 1,4-dihydroxycyclohexane, diethylene glycol, dipropylene glycol and 1,4-butanediol, 1,6-hexanediol, and bis(2-hydroxyethyl)hydroquinone, triols, such as 1,2,4- or 1,3,5-trihydroxycyclohexane, glycerol, and trimethylolpropane, and low-molecular-weight hydroxylated polyalkylene oxides based on ethylene oxide and/or on propylene 1,2-oxide, and on the abovementioned diols and/or triols, as starter molecules. The chain extenders (d) used particularly preferably comprise monoethylene glycol, 1,4-butanediol, diethylene glycol, glycerol, or a mixture thereof.

To the extent that chain extenders, crosslinking agents, or a mixture thereof are used, the amounts advantageously used of these are from 1 to 60% by weight, preferably from 1.5 to 50% by weight, and in particular from 2 to 40% by weight, based on the weight of components b) and d).

Catalysts e) used for producing the polyurethane foams preferably comprise compounds which markedly accelerate the reaction of the polyols b) and optionally chain extenders and crosslinking agents d), and also chemical blowing agent (c), with the organic, optionally modified polyisocyanates a). Examples that may be mentioned are amidines, such as 2,3-dimethyl-3,4,5,6-tetrahydropyrimidine, tertiary amines, such as triethylamine, tributylamine, dimethylbenzylamine, N-methyl-, N-ethyl-, or N-cyclohexylmorpholine, N,N,N′,N′-tetramethyl-ethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. Organometallic compounds can also be used, preferably organotin compounds, such as stannous salts of organic carboxylic acids, e.g. stannous acetate, stannous octoate, stannous ethylhexoate, and stannous laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth(III) neodecanoate, bismuth 2-ethylhexanoate, and bismuth octanoate, or a mixture thereof. The organometallic compounds can be used alone or preferably in combination with strongly basic amines. If component (b) is an ester, it is preferable to use exclusively amine catalysts.

The amount of catalyst or catalyst combination used, based on the weight of component b), is preferably from 0.001 to 5% by weight, in particular from 0.05 to 2% by weight. However, the selection of the catalysts, and the amounts used of these, are preferably such that a polyurethane foam molding can be demolded after at most 10 minutes, particularly preferably after 7 minutes, and in particular after at most 5 minutes. These stated times are based on the interval between introduction of the reaction mixture into the mold and defect-free demoldability of the polyurethane foam moldings.

In one preferred embodiment of the invention, the cream time of the polyurethane reaction mixtures is from 1 to 25 seconds, preferably from 3 to 20 seconds, particular preference being given to a cream time of from 5 to 15 seconds, and the full rise time of these mixtures is from 30 to 120 seconds, preferably from 35 to 90 seconds. The cream time here is the time that expires after the mixing of components (a) to (c) and optionally (d) to (f) before volume expansion begins, and the full rise time is the interval between introduction of the reactive system and the end of volume expansion.

Auxiliaries and/or additives f) can also optionally be added to the reaction mixture for producing the polyurethane foams. Mention may be made by way of example of surfactant substances, foam stabilizers, cell regulators, further release agents, fillers, dyes, pigments, hydrolysis stabilizers, odor-absorbing substances, and fungistatic and/or bacteriostatic substances.

Examples of surfactants that can be used are compounds which serve to promote the homogenization of the starting materials and optionally are also suitable for regulating the cell structure. Examples that may be mentioned are emulsifiers, such as the sodium salts of castor oil sulfates or of fatty acids, and also salts of fatty acids with amines, e.g. diethylamine oleate, diethanolamine stearate, diethanolamine ricinolate, salts of sulfonic acids, e.g. the alkali metal or ammonium salts of dodecylbenzene- or dinaphthylmethanedisulfonic acid, and ricinoleic acid; foam stabilizers, such as siloxane-oxalkylene copolymers and other organopolysiloxanes, ethoxylated alkylphenols, ethoxylated fatty alcohols, paraffin oils, castor oil esters or ricinoleic esters, Turkey red oil, and peanut oil, and cell regulators, such as paraffins, fatty alcohols, and dimethylpolysiloxanes. For improvement of emulsifying action, or the cell structure, and/or stabilization of the foam, other suitable substances are oligomeric acrylates having polyoxyalkylene and fluoroalkane radicals as side groups. The amounts usually used of the surfactants are from 0.01 to 5 parts by weight, based on 100 parts by weight of component b).

Examples that may be mentioned of suitable other release agents are: reaction products of fatty esters with polyisocyanates, salts derived from polysiloxanes comprising amino groups and fatty acids, salts derived from saturated or unsaturated (cyclo)aliphatic carboxylic acids having at least 8 carbon atoms and tertiary amines, and also in particular internal lubricants, e.g. carboxylic esters and/or carboxamides, produced via esterification or amidation of a mixture composed of montanic acid and of at least one aliphatic carboxylic acid having at least 10 carbon atoms with at least dibasic alkanolamines, polyols, and/or polyamines whose molar masses are from 60 to 400 g/mol, as disclosed by way of example in EP 153 639, or with a mixture composed of organic amines, metal stearates, and organic mono- and/or dicarboxylic acids or their anhydrides, as disclosed by way of example in DE-A 36 07 447, or a mixture composed of an imino compound, of a metal carboxylate and optionally of a carboxylic acid, as disclosed by way of example in U.S. Pat. No. 4,764,537. It is preferable that reaction mixtures of the invention do not comprise any other release agents.

Fillers, in particular reinforcing fillers, are the usual organic and inorganic fillers, reinforcing agents, weighting agents, coating agents, etc. that are known per se. Individual fillers that may be mentioned by way of example are: inorganic fillers, such as silicatic minerals, e.g. phyllosilicates, such as antigorite, bentonite, serpentine, hornblendes, amphiboles, chrysotile, and talc, metal oxides, such as kaolin, aluminum oxides, titanium oxides, zinc oxide, and iron oxides, metal salts, such as chalk and baryte, and inorganic pigments, such as cadmium sulfide, and zinc sulfide, and also glass, etc. It is preferable to use kaolin (China clay), aluminum silicate, and coprecipitates made of barium sulfate and aluminum silicate. Examples of organic fillers that can be used are: carbon black, melamine, colophony, cyclopentadienyl resins, and graft polymers, and also cellulose fibers, polyamide fibers, polyacrylonitrile fibers, polyurethane fibers, and polyester fibers, where these are based on aromatic and/or aliphatic dicarboxylic esters, and in particular carbon fibers.

The inorganic and organic fillers can be used individually or in the form of a mixture, and the amounts of these advantageously added to the reaction mixture are from 0.5 to 50% by weight, preferably from 1 to 40% by weight, based on the weight of components a) to d).

The present invention also provides a process for producing a polyurethane foam molding, in particular an integral polyurethane foam, in which the amounts of components a) to c) and optionally d), e), and/or f) mixed with one another are such that the equivalence ratio of NCO groups of the polyisocyanates (a) to the entirety of the reactive hydrogen atoms of components (b), (c), and (d) is from 1:0.8 to 1:1.25, preferably from 1:0.9 to 1:1.15 and particularly preferably from 0.91 to 1.05. A ratio of 1:1 here corresponds to an isocyanate index of 100. For the purposes of the present invention, the isocyanate index means the stoichiometric ratio of isocyanate groups to groups reactive toward isocyanate, multiplied by 100.

The polyurethane foam moldings of the invention are preferably produced by the one-shot process with the aid of low-pressure or high-pressure technology, in open or closed, advantageously temperature-controlled molds. It is preferable that the polyurethane foam molding is produced by the low-pressure process in open molds. Once said mixture has been introduced, the open mold is sealed with a cover. The liquid polyurethane reaction mixture expands within the mold and changes from a liquid state to a solid state during the reaction, thus assuming the shape imparted by the mold. The molds are usually composed of metal, e.g. aluminum or steel. These procedures are described by way of example by Piechota and Rohr in “Integralschaumstoff” [Integral foam], Carl-Hanser-Verlag, Munich, Vienna, 1975, or in “Kunststoff-handbuch”, Band 7, Polyurethane [Plastics handbook, volume 7, Polyurethanes], 3rd edition, 1993, chapter 7. It is preferable that the molds here are not evacuated prior to introduction of the reaction mixture or during the foaming of the reaction mixture.

To this end, starting components a) to f) are preferably mixed at a temperature of from 15 to 90° C., and with particular preference from 25 to 55° C., and the reaction mixture is introduced optionally at increased pressure into the mold. The mixing can be carried out mechanically by means of a stirrer or of a stirrer screw, or at high pressure in what is known as the countercurrent injection process. The temperature of the mold is advantageously from 20 to 160° C., preferably from 30 to 120° C., with particular preference from 30 to 60° C. For the purposes of the invention, the mixture of components a) to f) here is termed reaction mixture when conversions in the reaction are smaller than 90%, based on the isocyanate groups.

The amount of the reaction mixture introduced into the mold is judged in such a way that the density of the polyurethane foam molding of the invention is from 100 to 300 g/L, preferably from 120 to 250 g/L, and with particular preference from 150 to 225 g/L. The amount of the system used is selected here in such a way as to give a compaction factor which is preferably at most 1.6, with particular preference from 1.1 to 1.5, and in particular from 1.2 to 1.4. The free-foamed density here is from 80 to 200 g/L, and preferably from 100 to 180 g/L.

The present invention further provides a polyurethane foam molding obtainable by this type of process.

The polyurethane foam moldings of the invention are preferably used as shoe sole, and with particular preference as (mid)sole, for example for everyday shoes, sports shoes, sandals, and boots. In particular, the integral polyurethane foams of the invention are used as midsole for sports shoes.

A process of the invention here leads, in particular via use of a mold with a pressure-control device, to polyurethane foam moldings of density from 100 to 300 g/L and with appropriately good surface quality. The process of the invention moreover solves problems such as skin detachment or inadequate foam morphology. The pressure-control device therefore permits use of less blowing agent, and it is therefore possible to avoid defects at the surface of the foam or in its morphology, where these are produced through continuing pressure from the blowing agent in foam structures that have to some extent already completed their formation. The process of the invention also reduces the amount of material that has to be discarded in the form of flash.

Examples will be used below to illustrate the invention.

### EXAMPLES

### Starting Materials Used

Polyol 1: polytetrahydrofuran with OH number 56 mg KOH/g
Polyol 2: polymer polyether polyol based on a trihydric polyether polyol with OH number 28 as carrier polyol and 45% by weight solids content, based on styrene/acrylonitrile
Polyol 3: polyesterol based on adipic acid, monoethylene glycol, and butanediol with OH number 56 mg KOH/g
Polyol 4: Hoopol® PM 445 from Synthesia (polyester polymer polyol)
Polyol 5: polyesterol based on adipic acid, monoethylene glycol, and butanediol with OH number 80 mg KOH/g
Cat1: Lupragen® N203 from BASF Polyurethanes
Cat2: Dabco® 1027 from Air Products
Cat3: catalyst based on imidazole derivatives
Cat4: bis(2-dimethylaminoethyl)ether dissolved in dipropylene glycol
Cat5: retarded amine catalyst
Stabi 1: Dabco® DC 193 from Air Products
Stabi 2: shear stabilizer based on polyether siloxanes
Stabi 3: cell stabilizer based on polyether siloxanes
Stabi 4: cell regulator from Goldschmidt
Stabi 5: LK 221 from Air Products
Cross1: trifunctional crosslinking agent with OH number 1160 mg KOH/g
Cross2: trifunctional crosslinking agent with OH number 1825 mg KOH/g
Chain: monoethylene glycol
ISO 1: ISO 137/28 from BASF Polyurethanes, prepolymer based on 4,4″-MDI and polyetherols having 18% NCO content
ISO 2: ISO 187/39 from BASF Polyurethanes, prepolymer based on 4,4″-MDI and polyesterols having 22% NCO content
ISO 3: ISO 187/43 from BASF Polyurethanes, prepolymer based on 4,4″-MDI and polyesterols having 18.2% NCO content
ISO 4: ISO 187/3 from BASF Polyurethanes, prepolymer based on 4,4″-MDI and polyesterols having 16.1% NCO content
ISO 5: prepolymer based on 4,4″-MDI
ISO 6: prepolymer based on 4,4″-MDI

### Production of ISO 5:

14.0 kg of monomeric diphenylmethane 4,4″-diisocyanate were used as initial charge in a prepolymer reactor with 4.8 kg of a mixture of three parts of monomeric diphenylmethane 4,4″-diisocyanate and one part of carbodiimide-modified diphenylmethane diisocyanate, and 4′10⁻⁴ kg of benzyl chloride, and the mixture was heated to a temperature of 60° C. Once this temperature had been reached, 21.2 kg of Polyol 5 were added slowly over a period of 30 minutes. After the addition, the mixture was heated to 80° C. and stirred at this temperature for 2 hours. The NCO content of the resultant prepolymer was 12.1%.

### Production of ISO 6:

22.8 kg of monomeric diphenylmethane 4,4″-diisocyanate were used as initial charge in a prepolymer reactor with 2.4 kg of a mixture of three parts of monomeric diphenylmethane 4,4″-diisocyanate and one part of carbodiimide-modified diphenylmethane diisocyanate, and 4*10⁻⁴ kg of benzyl chloride, and the mixture was heated to a temperature of 60° C. Once this temperature had been reached, 14.8 kg of Polyol 3 were added slowly over a period of 30 minutes. After the addition, the mixture was heated to 80° C. and stirred at this temperature for 2 hours. The NCO content of the resultant prepolymer was 19.3%.

The mixtures described in the examples were mixed with the appropriate isocyanate prepolymers in an EMB F20 low-pressure polyurethane machine and inserted across the entire mold. The mold here could be supported in either a flat or inclined position, as is conventional in shoe production.

The moldings were produced by using traditional shoe molds for production of midsoles. The mold for the left-hand sole served here as reference or comparison with respect to the traditional process, and the right-hand sole served as example of the process of the invention. In the process of the invention here, the right-hand sole mold was provided with appropriate pressure-release apertures of varying size. The following molds were used:
Mold 1:1 mm hole at forefoot, centrally, about 1 cm from edge
Mold 2: 5 2.5 mm holes, symmetrically distributed across the mold at equal distances (distance from edge of forefoot and hind portion of foot about 1 cm)
Mold 3: 5 holes symmetrically distributed across the mold at equal distances, dimensions of holes starting from the hind portion of the foot: 6 mm, 5 mm, 2.5 mm, 2.5 mm, 2.5 mm

All of the molds had a volume of 260 mL.

To determine free density, the mixture was allowed to rise freely in a beaker. The compaction factor was determined from the volume of the molding and the free density of the individual polyurethane systems, and was controlled by way of the amount of the reaction mixture introduced into the mold.

| | Comp. ex. 1 | Inv. ex. 1 |
|---|---|---|
| Polyol 1 | 78.507 | 78.507 |
| Polyol 2 | 9.621 | 9.621 |
| Chain | 8.274 | 8.274 |
| Cross1 | 0.241 | 0.241 |
| Cat 1 | 1.010 | 1.010 |
| Cat 2 | 0.433 | 0.433 |
| Cat 3 | 0.144 | 0.144 |
| Cat 4 | 0.289 | 0.289 |
| Stabi 1 | 0.183 | 0.183 |
| Water | 1.299 | 1.299 |
| ISO | ISO 1 | ISO 1 |
| Index | 96 | 96 |
| Cream time [s] | 7 | 7 |
| Full rise time [s] | 39 | 39 |
| FRD [g/L] | 138 | 138 |
| Mold | left-hand 1 | right-hand 1 |
| Amount weighed | 55.1 | 54.8 |
| into mold [g] | | |
| Form fill | no | yes |
| Density of | — | 210 |
| molding [g/L] | | |
| Foam structure | / | ++ |
| Surface quality | / | ++ |

| | Comp. ex. 2 | Inv. ex. 2 | Comp. ex. 3 | Inv. ex. 3 | Comp. ex. 4 |
|---|---|---|---|---|---|
| Polyol 3 | 42.50 | 42.45 | 42.50 | 42.45 | 42.45 |
| Polyol 4 | 42.50 | 42.50 | 42.50 | 42.50 | 42.50 |
| Chain | 12.00 | 12.00 | 12.00 | 12.00 | 12.00 |
| Cross2 | 0.5 | 0.5 | 0.5 | 0.5 | 0.5 |
| Cat 1 | 0.3 | 0.3 | 0.3 | 0.3 | 0.3 |
| Cat 5 | 1.70 | 1.70 | 1.70 | 1.70 | 1.70 |
| Stabi 2 | 0.5 | 0.5 | 0.5 | 0.5 | 0.5 |
| Stabi 3 | 0.5 | 0.5 | 0.5 | 0.5 | 0.5 |
| Stabi 4 | 1.0 | 1.0 | 1.0 | 1.0 | 1.0 |
| Water | 1.15 | 1.15 | 1.15 | 1.15 | 1.15 |
| ISO | ISO 3 | ISO 3 | ISO 4 | ISO 4 | ISO 5 |
| Index | 95 | 95 | 95 | 95 | 95 |
| Cream time [s] | 11 | 11 | 12 | 12 | 14 |
| Full rise time [s] | 55 | 55 | 70 | 70 | 70 |
| FRD [g/L] | 129 | 129 | 142 | 142 | 162 |
| Mold | left-hand 2 | right-hand 2 | left-hand 2 | right-hand 2 | right-hand 2 |
| Amount weighed | 53.2 | 52.5 | 52.8 | 52.9 | 52.1 |
| into mold [g] | | | | | |
| Form fill | no | yes | no | yes | no |
| Density of | — | 202 | — | 203 | — |
| molding [g/L] | | | | | |
| | Comp. ex. 5 | Inv. ex. 4 | Inv. ex. 5 | Comp. ex. 6 | Inv. ex. 6 |
| Polyol 3 | 42.50 | 42.45 | 42.50 | 42.50 | 42.50 |
| Polyol 4 | 42.50 | 42.50 | 42.50 | 42.50 | 42.50 |
| Chain | 12.00 | 12.00 | 12.00 | 12.00 | 12.00 |
| Cross2 | 0.5 | 0.5 | 0.5 | 0.5 | 0.5 |
| Cat 1 | 0.3 | 0.3 | 0.3 | 0.3 | 0.3 |
| Cat 5 | 1.70 | 1.70 | 1.70 | 1.70 | 1.70 |
| Stabi 2 | 0.5 | 0.5 | 0.5 | 0,5 | 0.5 |
| Stabi 3 | 0.5 | 0.5 | 0.5 | 0.5 | 0.5 |
| Stabi 4 | 1.0 | 1.0 | 1.0 | 1.0 | 1.0 |
| Water | 1.15 | 1.15 | 1.15 | 1.15 | 1.15 |
| ISO | ISO 2 | ISO 2 | ISO 2 | ISO 2 | ISO 2 |
| Index | 95 | 95 | 95 | 95 | 95 |
| Cream time [s] | 9 | 9 | 9 | 9 | 9 |
| Full rise time [s] | 49 | 49 | 49 | 49 | 49 |
| FRD [g/L] | 112 | 112 | 112 | 112 | 112 |
| Mold | left-hand 2 | right-hand 2 | right-hand 2 | left-hand 3 | right-hand 3 |
| Amount weighed | 71.5 | 71.3 | 46.5 | 65.1 | 64.9 |
| into mold [g] | | | | | |
| Form fill | yes | yes | yes | yes | yes |
| Density of | 275 | 275 | 180 | 250 | 250 |
| molding [g/L] | | | | | |
| Flash/overflash [g] | 1.98 | 0.92 | | 1.59 | 0.64 |
| Comment | | | | homo- | heel |
| | | | | geneous | hardness |
| | | | | hardness | differs from |
| | | | | | forefoot |
| | | | | | hardness |

| | Comp. ex. 7 | Inv. ex. 7 |
|---|---|---|
| Polyol 3 | 86.35 | 86.35 |
| Chain | 9.09 | 9.09 |
| Cat 1 | 0.80 | 0.80 |
| Cat 3 | 0.20 | 0.20 |
| Cat 5 | 0.60 | 0.60 |
| Stabi 2 | 0.27 | 0.27 |
| Stabi 3 | 0.27 | 0.27 |
| Stabi 4 | 1.0 | 1.0 |
| Stabi 5 | 0.27 | 0.27 |
| Water | 1.15 | 1.15 |
| ISO | ISO 6 | ISO 6 |
| Index | 95 | 95 |
| Cream time [s] | 9 | 9 |
| Full rise time [s] | 42 | 42 |
| FRD [g/L] | 137 | 137 |
| Mold | left-hand 2 | right-hand 2 |
| Amount weighed | 54.1 | 53.9 |
| into mold [g] | | |
| Form fill | no | yes |
| Density of | — | 207 |
| molding [g/L] | | |
| Hardness | — | 50 |
| [Asker C] | | |
| Tensile strength | — | 2.1 |
| [N/mm²] | | |
| Elongation [%] | — | 273 |
| Tear propagation | — | 2.13 |
| resistance [N/mm] | | |

Asker C hardness here was determined to JIS K 7312, tensile strength and elongation were determined to DIN 53504, and tear propagration resistance was determined to ASTM D3574.

As can be seen from the examples, the combination of PU systems with appropriate mold design leads to better mold fill, and less production waste (flash or overflash), and can be utilized to establish a hardness/density gradient within the sole.

1. A process for producing polyurethane foam moldings of density from 100 to 300 g/L, by mixing
a) organic polyisocyanates with
b) polyols,
c) with blowing agents comprising water, and optionally
d) with chain extenders and/or with crosslinking agents,
e) with catalysts, and
f) with other auxiliaries and/or additives,
to give a reaction mixture, charging the material to a mold, and permitting it to react completely to give a polyurethane foam molding, where the free density of the polyurethane foam is from 90 to 200 g/L, and the mold has at least one device for controlling gauge pressure.

2. The process according to claim 1, wherein the isocyanate (a) is an isocyanate prepoly-mer having from 14 to 23% by weight isocyanate content.

3. The process according to claim 1 or 2, wherein the cream time for the polyurethane reaction mixture is from 1 to 25 seconds and the full rise time is from 30 to 120 seconds, and the compaction factor is at most 1.6.

4. The process according to any of claims 1 to 3, wherein the blowing agents c) comprise no physical blowing agents.

5. The process according to claim 4, wherein the blowing agent (c) is exclusively water, and the proportion of water, based on the total weight of components (a) to (e), is from 0.1 to 3% by weight.

6. The process according to any of claims 1 to 5, wherein the mold has precisely one device for controlling gauge pressure.

7. The process according to any of claims 1 to 5, wherein the mold has from 2 to 10 devices for controlling gauge pressure.

8. The process according to claim 7, wherein the devices for controlling gauge pressure are apertures in the mold with different aperture-area dimensions.

9. The process according to any of claims 1 to 8, wherein the devices for controlling gauge pressure are one or more apertures in the mold with a longest-axis diameter of from 1 mm to 5 mm.

10. The process according to claim 8 or 9, wherein the aperture area of a device for controlling gauge pressure is respectively from 0.7 mm² to 19 mm².

11. The process according to any of claims 1 to 10, wherein the demolding time is smaller than 7 minutes.

12. The process according to any of claims 1 to 11, wherein the water content is from 0.7 to 1.5% by weight, based on the total weight of components b) to f).
